(19) United States
(12) Patent Application Publication
(10) Pub. No.: US 2016/0309963 A1
(43) Pub. Date: Oct. 27, 2016

(54) LID HOLDING DEVICE

(71) Applicant: Daniel E. FRITZINGER, Tamaqua, PA (US)

(72) Inventor: Daniel E. FRITZINGER, Tamaqua, PA (US)

(21) Appl. No.: 14/693,930

(22) Filed: Apr. 23, 2015

(51) Int. Cl. A47J 47/16; F16M 11/24

(52) U.S. Cl. CPC A47J 47/16; F16M 11/24

(57) ABSTRACT

A lid holding device 1 is designed to hold one of a variety of different lids 8 over a pot 6, such as a crock pot. The lid holding device 1 comprises a flat base 2, an extension 3 which can be set to an adjustable angle relative to the base 2, and hold the extension 3 and attachment 4 in a desired leaning angle. The heavy pot and its contents rest on a base 2, stabilizing the device 1. When the lid 8 is removed from the pot 6, the handle 9 of the lid 8 is held by the attachment 4 preventing any touching of the inside of the lid or pot reducing contamination of the inside of the lid and pot. The leaning angle of the extension 4 and the length of the extension and attachment can be adjusted to accommodate different lid sizes and shapes 8, causing each to be held vertically or at an angle above the pot 6. Holding the lid 8 above the pot 6 at the desired angle allows liquids on the inside of the lid to drain and drip back into the pot 6 preventing any liquids in the lid from falling on other surfaces causing a mess. The attachment 4 is designed to hold a variety of lid handles. It has at least two upward projections 27 extending upward from the attachment 4, the projections 27 becoming narrower as they extend upward. This allows the attachment 4 to fit between ends of a loop handle of a lid to secure the loop handle and lid. There are also horizontal projections 29 for holding wider loop handles 9. A rest 13 at the bottom of a recess 14 receives a knob handle 9. Recess 14 may be angled to accept larger knob handles.

### CROSS-REFERENCE TO RELATED APPLICATIONS

This application is a continuation-in-part (CIP) of U.S. patent application Ser. No. 13/872,185 filed Apr. 29, 2013 “Crock Pot Lid Holder and Stand” which claims priority under 35 U.S.C. §119(e)(1) from U.S. Provisional Patent Application No. 61/640,532, filed on Apr. 30, 2012, for “Crock Pot Lid Holder and Stand” all of which are incorporated by reference as if set forth in their entirety herein.

### STATEMENT REGARDING FEDERALLY SPONSORED RESEARCH

Not Applicable.

### BACKGROUND

1. Field of Invention

The present invention relates to stands and holders for lids, and more particularly relates to adjustable stands and holders that are adapted to hold various types of pot lids and crock pot lids.

2. Description of Related Art

Many homemakers as well as chefs utilize various utensils and appliances in the kitchen to assist in the preparation and service of food. A slow cooker (i.e., a crock pot) of the type commonly known in the art is an example of a combination kitchen utensil which purposefully cooks and warms food at a low temperature for a predetermined period of time. Given its desired capacity to slow cook and warm a modest amount of food, the crock pot is most notably used and observed at large gatherings, such as conferences, receptions, family meetings and so forth. To facilitate the cooking process and guard against heat-related injuries stemming from splattered foods, most crock pots comprise a cover or lid made from glass or heavy material. The lid, in most instances, is heavily weighted insofar to fit tightly atop a cylindrical-shaped, heat-equipped reservoir and is geometrically configured to resemble a dome or semi-flattened plate having a handle outwardly extending therefrom.

During the cooking process as well as during moments of serving food, the homemaker or chef is periodically confronted with the requirement of removing the lid from the crock pot and finding a suitable location for the lid while one is gaining access to the food inside. In order to alleviate this concern most effectively, a range of cover handling devices have been developed. During cooking, condensation develops on the inside of the lid. Also, any agitation of the pot or bubbling due to boiling, causes sauces, or other liquids in the pot to splash onto the inside of the pot and lid. Once the lid is removed, these liquids can leak onto other surfaces causing a mess.

Also, since the pot holds foods, contamination of the inside of the pot or lid should be prevented. This is done by preventing any physical touching of outside surfaces to inside surfaces. Liquids that came in contact with any outside surfaces and picked up contamination should not be allowed to be allowed to contact the inside surfaces of the pot or lid, contaminating them.

Also, it is common for people to bring their own crock pot of food for a covered dish get together or other event such as a party. Since pots vary in size and shape, any stands or holders must be able to accommodate various sized and shaped pots and lids.

The most simplistic device for holding a lid comprises a pot handling glove or pad having insulating characteristics, while a more advanced device comprises a lid holder of the type that can simultaneously engage the lid's handle and sidewall of the cooking utensil. Although this type of handling device still requires one to directly interact with and handle the cover, albeit at a modest level, it does facilitate placement of the lid next to the crock pot, thus suitably serving as a location for the lid.

One of the other attempts to provide a lid holder was disclosed in U.S. Pat. No. 5,396,993 Spitler, Mar. 14, 1995. It provides a stand on which to place a lid to hold it horizontally. As indicated above, since the inside of the lid is placed upon the parallel legs 26 and 27 of FIG. 1, there is contamination of the inside of the lid. Also, since the base 11 is not flat, a pot cannot easily be placed on the base 11.

Since the lid typically has condensation and possibly other liquids on its inside surface, and is now placed horizontally, it cannot easily drain. Therefore, even if liquids from the lid were able to drain off, there is nowhere for them to go but on the base 11 and surface where the base is located, causing a mess.

U.S. Patent Publication Number US 2009/0230134 A1 Romandy, published Sep. 17, 2009 discloses another attempt to provide a lid holder. The Romandy device is designed only to hold one specific type of lid, having a knob as a handle. It is also designed to only hold that size of a knob handle. Therefore, the device of Romandy would not be effective in holding loop handles or knob handles of a size other than the one it is designed to hold.

U.S. Pat. No. 8,727,139 B1 Sventek et al., May 20, 2014 discloses a device which also attempts to hold a lid. Sventek employs a stand with a stop member 41z and a right member 41r which form a lip extending horizontally from the stand. A lid is intended to be placed in and held by members 41r and 41z as shown in Sventek, FIG. 6. Even though this design holds the lid in a substantially vertical position, any liquids on the inside of the lid drain into the stop member 41r and 41z. This causes the liquids to cover the inside making a mess. If enough liquid accumulates in members 41r and 41z, then the liquids will cover the outside of the lid and run back to make contact with the inside of the lid contaminating it.

In accordance With the present invention, applicant has appreciably devised an apparatus comprising a means for holding and supporting the lid to the crock pot in order to allow access to the food inside.

Currently, there is a need for a device for holding various sizes and shapes of pot lids without contaminating the inside of the lid or pot and preventing any liquids on the inside of the lid or pot to be spread to other surfaces.

### SUMMARY

The present invention is an adjustable holder and stand for a lid of a pot, such as a crock pot. One embodiment of the present invention comprises a wide base with an extension rising vertically and perpendicularly from the base. As part of such an embodiment, an attachment is attached to the top of the extension using a fastener which may be a wingnut and screw or other conventional fastening device. The attachment can be moved up and down the top of the extension via a through mortise in the extension. The attachment is comprised of two prongs which are shaped to hold the crock pot lid in place by sliding the groove created between the crock pot lid and the lid's handle into the rest between the two prongs.

The invention may also be embodied as a lid holding device 1 for holding a lid 8 by a handle 9 above a pot 6 having a flat base adapted to support the pot, an extension attached to the flat base extending at an angle upwardly from the flat base; and an attachment connected to the extension sized and shaped to receive and hold said handle 9 causing the lid 9 to be in a substantially vertical position over the pot.

The current invention may also be embodied as a lid holding device 1 adaptable to a variety of different lids 8 having a flat base 2 for receiving and supporting a pot 6, an extension 3 extending upward at an angle toward the pot 6, an attachment 4 adjustably coupled to the extension 3 to adjust a total length of the extension 3 and attachment 4. The attachment 4 has at least two upward projections 27 extending upward from the attachment 4, the projections 27 becoming narrower as they extend upward, sized and shaped to fit between ends of a loop handle 9 of a lid 8 to hold the lid 8 by the loop handle 9. Attachment 4 also includes a recess 14 with a curved rest 13 for holding and securing a knob handle 9 of a lid 8.

### BRIEF DESCRIPTION OF THE DRAWINGS

FIG. 1 is a perspective view of a lid holding device consistent with one embodiment of the present invention.

FIG. 2 is a perspective view of a lid holding device of FIG. 1 as it would appear in use.

FIG. 3A is a rear perspective view of a lid holding device consistent with another embodiment of the current invention shown in FIGS. 3A-3E as it would appear in use.

FIG. 3B is a front perspective view of a lid holding device of the embodiment of FIG. 3A-3E.

FIG. 3C is a side elevational view of a lid holding device of the embodiment of FIG. 3A-3E.

FIG. 3D is rear elevational view of the embodiment shown in FIGS. 3A-3E.

FIG. 3E is a top plan view of the embodiment of FIGS. 3A-3E.

FIG. 4 shows an embodiment of the lid holding device that can accept and hold a lid with a small loop handle.

FIG. 5, shows an embodiment of the lid holding device that can accept and hold a lid with a large loop handle.

FIG. 6 shows an embodiment of the lid holding device that can accept and hold a lid with a knob handle.

FIG. 7A shows a perspective view of the embodiment of the lid holding device of FIGS. 4-6, showing its leaning angle.

FIG. 7B shows a front elevational view of the embodiment of the lid holding device of FIGS. 4-6.

FIG. 8 is an enlarged partial front elevational view of the attachment of FIGS. 4-6.

FIG. 9 shows a partial side elevational view of the embodiment of FIG. 7A.

FIG. 10 is a perspective view of another embodiment of the lid holding device having an adjustable extension leaning angle.

FIG. 11 shows how the extension and the attachment are arranged for storage.

FIG. 12 shows how the base is arranged with the extension and attachment for storage.

FIG. 13A, 13B and 13C show different views of the base attached to the extension and attachment for storage.

FIG. 14 is a top plan view of an oval crock pot and matching lid showing how the base, extension and attachment can be attached to each other and able to be stored inside of the crock pot.

### DETAILED DESCRIPTION

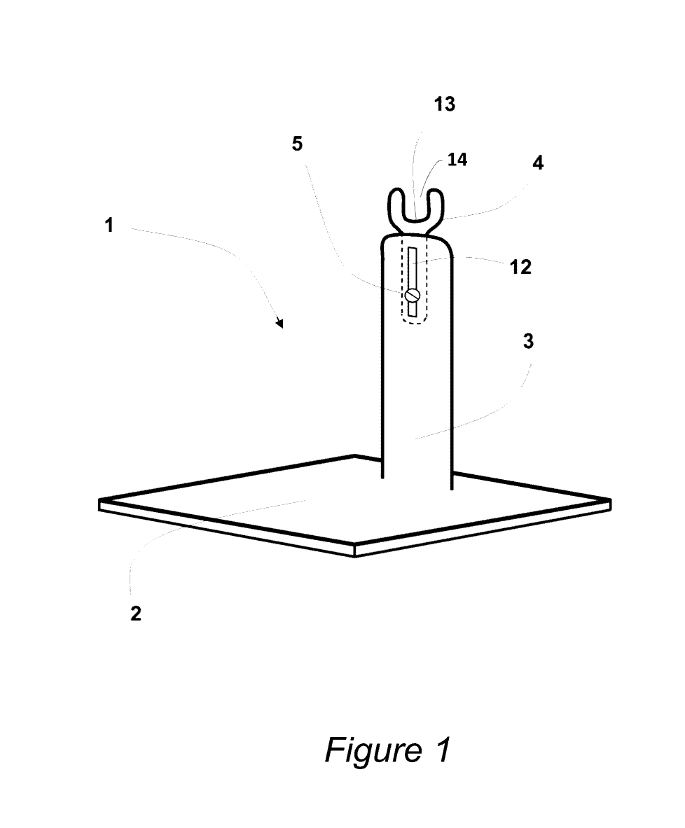

Referring to FIG. 1, a first embodiment of a pot lid holding device 1 is shown in isolation. The lid holding device 1 comprises a flat base 2, an extension 3, and an attachment 4. The flat base 2, extension 3, and attachment 4 can be constructed out of any solid material such as metal, wood, and/or plastic. The extension 3 is connected to the flat base 2 by any permanent or temporary connection means. In this embodiment of the invention, the extension 3 is secured directly to the flat base 2. In an alternative embodiment, the extension 3 is attached to the flat base 2 by a mortise and tendon joint. This effectively allows one to adjust the amount the base 2 extends in front of the extension 3. The extension 3 is attached to the flat base 2 in such a way that it extends upward from the horizontal plane of the flat base 2.

An attachment 4 is attached to the top portion of the extension 3. As shown in FIG. 1, a conventional fastener 5 which may be a conventional screw and wing nut, or other conventional fastener may be used to attach the attachment 4 to the extension 3. Any conventional means of attachment can be used, which allows the total length of extension 3 and attachment 4 to be adjusted.

In certain embodiments of the invention, the attachment 4 can be adjusted up and down along the length of the extension 3 through the use of a through mortise 12 cut into the length of the extension 3 as is shown in FIG. 1. A recess 14 in the end of attachment 4 has a curved rest 13 that serves to hold a knob handle of the pot lid in place.

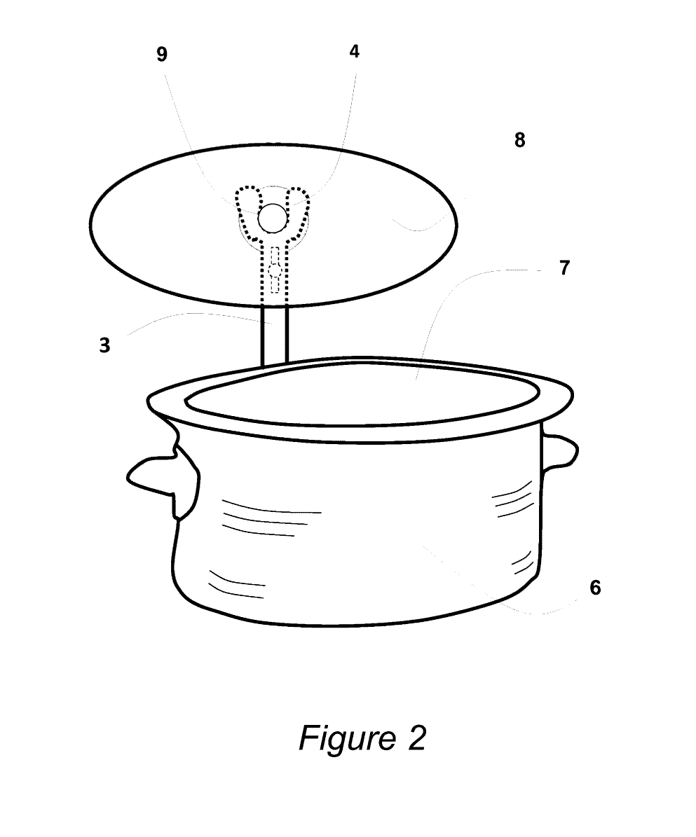

FIG. 2 illustrates the embodiment of the present invention shown in FIG. 1 in use. As shown, a pot 6, which may be a crock pot, is placed on top of the flat stand so that the extension 3 is placed behind pot 6. The weight of the pot 6 and its contents rest, at least partially, upon base (under pot 6), stabilizing the lid holding device. Typically, the pot 6 is a crock pot filled with food. It has considerable weight and can easily stabilize the base 2.

The lid 8 of the crock pot 6 shown in FIG. 2 typically made of glass, has been removed from the opening 7. The handle 9 of the lid 8 in this example is a knob handle. The knob handle 9 is placed on rest 13 of the attachment 4, as shown in FIG. 2, thereby holding the lid 8 in place. Preferably, the extension 3 is attached to the base 2 by an angle less than 90 degrees causing the extension and attachment 4 to lean toward the pot 6. This leaning angle allows the lid 8 to be held over the pot 6 such that condensation and any contents (food) of the pot which splashed up on the inside of lid 8 can run downward and drip into the pot 6. In other embodiment of this invention, the lid holding device has an adjustable angle between the base 2 and extension 3 to adjust to accommodate different lids having different lid heights.

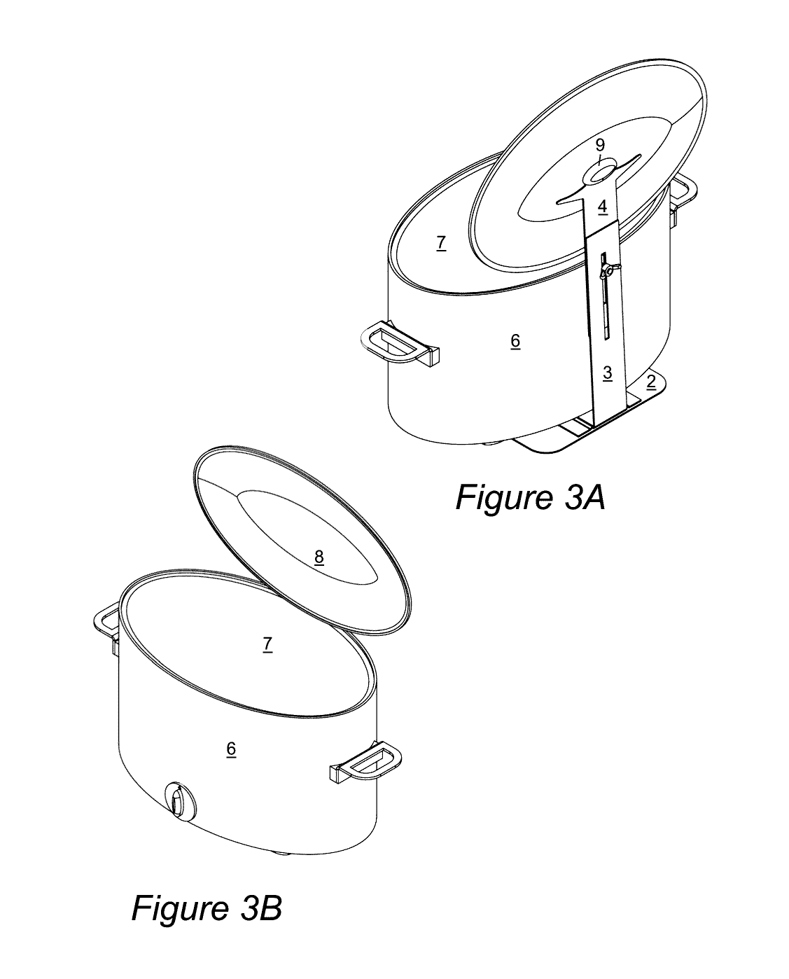

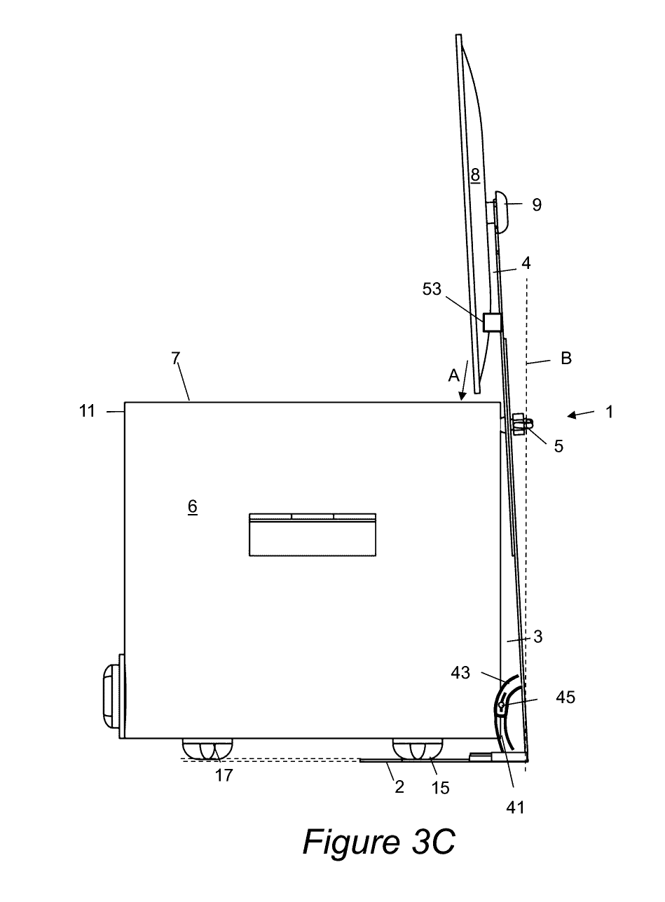

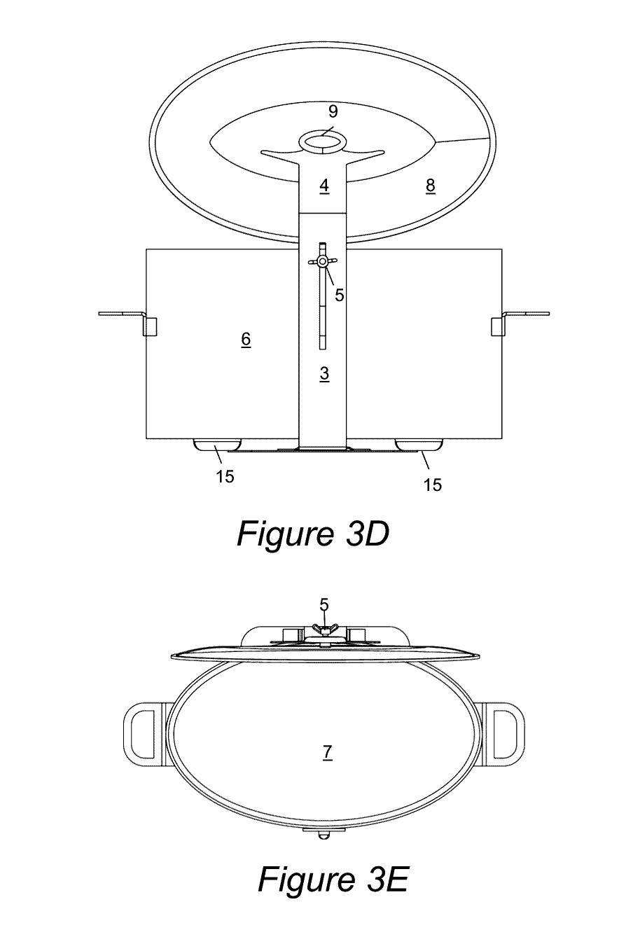

FIG. 3A is a rear perspective view of a lid holding device consistent with another embodiment of the current invention shown in FIGS. 3A3E as it would appear in use.

FIG. 3B is a front perspective view of a lid holding device of the embodiment of FIG. 3A-3E.

FIG. 3C is a side elevational view of a lid holding device of the embodiment of FIG. 3A-3E.

FIG. 3D is rear elevational view of the embodiment shown in FIGS. 3A-3E.

FIG. 3E is a top plan view of the embodiment of FIGS. 3A-3E.

Referring to the embodiment shown in FIGS. 3A-3E, the base 2 fits only partially under pot 6. Near feet 15 of pot 6 rest upon the base 2. The extension 3 is attached to the base 2 and extends upward at a slight angle leaning toward the pot 6. This can be seen when compared to a vertical line indicated by dashed line “B”. The leaning angle may be adjusted by an optional hinged mechanism shown in FIG. 10 and described below.

Since the pot is typically a crock pot, it has significant weight. Also, since the pot 6 is typically filled with food, there is additional weight. The weight of the crock pot 6 and food rest on the base 2, securing it. The weight resting on the base 2 also secures the extension 3, attachment 4, and the lid 8. This is important, since the lid 8 typically is glass and also has significant weight, and the extension 3 and attachment 4 create a long arm which acts as a lever. Therefore, there must be significant weight securing base 2 to steady the lid 8, attachment 4 and extension 3.

In an alternative embodiment, shown with dashed lines, base 2 extends substantially across the width of the pot 6 and is also under the far feet 17 of the pot 6. This adds greater stability since it is now being anchored at four locations. In alternative embodiments, base 2 can be extendable to reach under all feet 15 and 17 (or substantially across the bottom of the pot) but slide or fold to be small enough to be stored in the pot 6 for travel. (When used with pots that do not have feet, the bottom of the pot 6 simply rests upon base 2.)

Since the weight of the pot 6 stabilizes the lid holding device, it is important that the base 2 is substantially flat to receive pot 6.

FIG. 3C optionally includes one or more adjustable stabilizing structures 53. These extend substantially horizontally toward the outer surface of the lid when it is being held. These can place the lid at a proper angle to drain into the pot while not blocking access to the pot opening 7. Using more than one stabilizing structure 53 spaced horizontally will add more support to the lid, preventing it from being knocked off of the device.

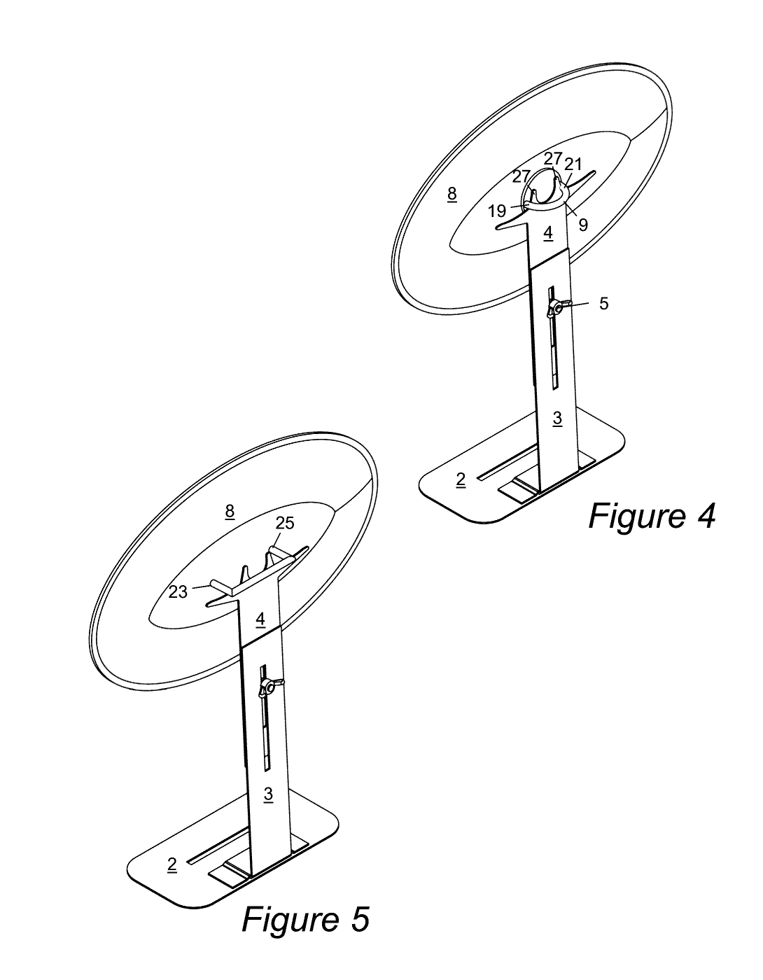

FIG. 4 shows the lid 8 having a small loop handle 9. The small loop handle 9 has a left side 19 and a right side 21 of loop handle 9 close to where they attach to lid 8. The attachment 4 includes a pair of upward projections 27. The left side 19 and right side 21 of handle 9 are shown straddling the upward projections 27 thereby holding loop handle 9 and lid 8.

FIG. 5 shows the lid 8 having a large loop handle 9 being held by the lid holding device 1. The lid 8 is shown in a vertical orientation being held by attachment 4. Here, a left side of loop handle 9 is shown where it attaches to lid 8 has reference number 23. Similarly, a right side of loop handle 9 is shown where it attaches to lid 8 and has reference number 25. The attachment 4 also includes a pair of horizontal arms 29. A left side 23 and right side 25 of handle 9 are supported by the horizontal arms 23, 25 as shown.

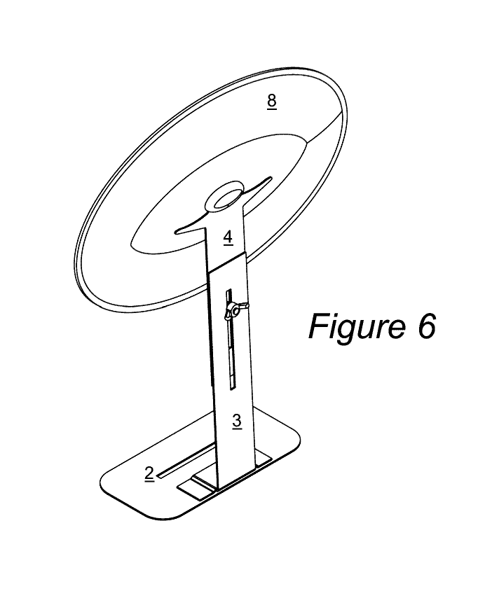

FIG. 6 shows an embodiment of the lid having a knob handle 9 being held by the lid holding device 1. The rest 13 is between the upward projections 27 receives and holds a single knob handle 9 as shown.

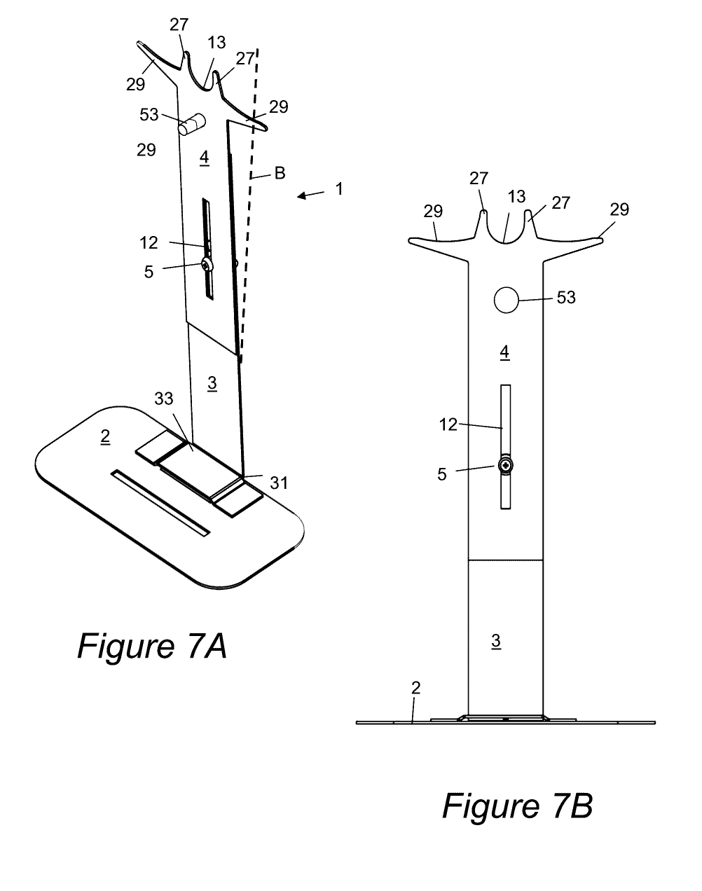

FIG. 7A shows a perspective view of the embodiment of the lid holding device of FIGS. 4-6, showing its leaning angle.

FIG. 7B shows a front elevational view of the embodiment of the lid holding device of FIGS. 4-6. Now referring to both FIGS. 7A and 7B, the attachment 4 includes a rest 13, upward projections 27, and horizontal arms 29. The attachment 4 is attached to the extension 3 with a fastener 5. Also as indicated, there is a mortise 12 in at least one of the attachment 4 or the extension 3 allowing the total height of the extension 3 and attachment 4 to be adjustable. The extension 3 is attached to the base 2. In this embodiment, the lower end of extension 3 has an angled portion 31 that is held within an extension slot 33.

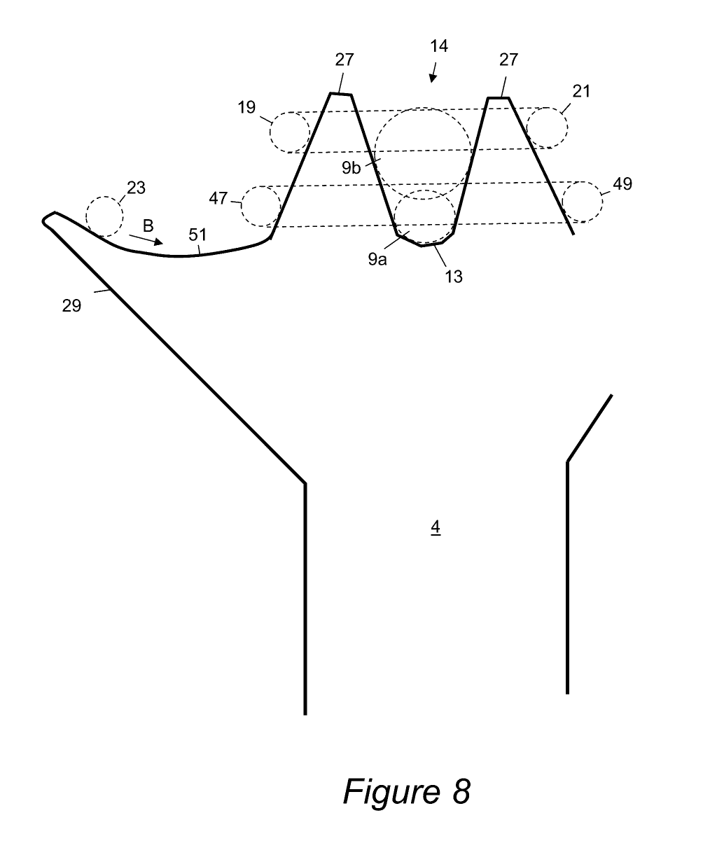

FIG. 8 is an enlarged partial front elevational view of the attachment of FIGS. 4-6. In FIG. 8, the upward projections 27 are wider as they extend downward. As was show in in FIG. 4, a small loop handle would have a cross section where it attaches to the lid shown by dashed circles 19 and 21. When the small loop handle is placed over the upward projections 27, the ends 19 and 21 of the handle slide down to where they meet the surface of the projections 27, securing the lid.

If a larger loop handle is used, the cross sections 47 and 49 slide down the upward projections 27 until they rest against the surface of upward projections 27.

If a lid with a very large loop handle is used, it rests on horizontal projections 29. The dashed circle 23 represents a left cross section of the loop handle resting on the horizontal projection 29. The upper surface of horizontal projection 29 has an arc shape 51 with the lowest point being near the middle of the arc. Therefore, handle cross section 23 would fall by gravity downward toward the center of the arc. This happens on both sides of the handle, functioning to center the handle on the extension 4.

The attachment 4 includes a rest 13 at the bottom of a curved recess 14 between the upward projections 27 adapted to receive a knob handle of a pot lid of various sizes and secure the pot lid.

As shown, a portion 9a of the knob handle which connects to the remainder of the lid is shown as a dashed circle. Due to its small size, it falls to the bottom of the rest 13 and is secured there by the inner sides of upward projections 27.

A lid with a larger diameter portion 9b of a knob handle, would be secured against the sides of upward projections 27 before it reaches the bottom of rest 13.

Therefore, this design of this embodiment of the present invention can accommodate and hold lids with handles having various sizes and shapes. Since most of the handles on the market for crock pots fall into the categories shown and described above, the present invention could be used to hold most lids currently on the market.

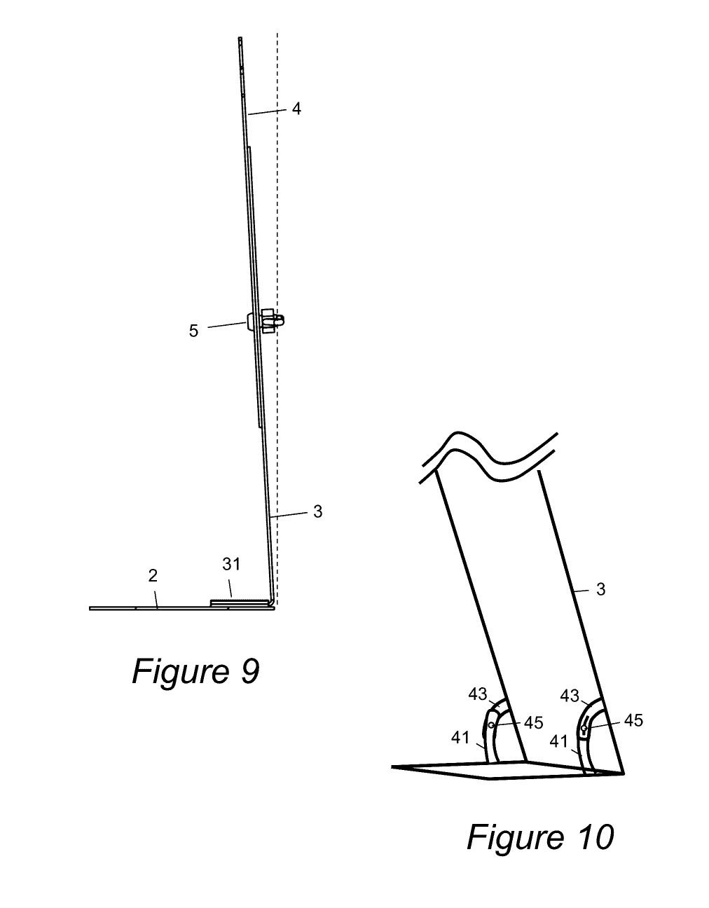

FIG. 9 shows a side elevational view of the embodiment of FIGS. 7A and 7B. Any known attachment may also be used in place of the screw 35 and wingnut 37, as would be commonly known by a person of ordinary skill in the art.

FIG. 10 is a perspective view of a portion of another embodiment of the lid holding device showing an angle adjustment mechanism 40 that allows an adjustable leaning angle for extension 4. The extension 3 is pivotally connected to the base 2 to allow an adjustable leaning angle. There is a curved sliding member 43 attached to the extension which slides against another sliding member attached to the base 2 when the extension 3 is moved relative to the base 2. When the angle between them is at a desired angle, the sliding members are attached to each other with a securing device 45 fixing the leaning angle. This allows the lid holding device to adjust the leaning angle of the extension 3 and attachment 4, allowing it to accommodate lids of various heights and properly position them over the pot. This allows the drippings of the lid to drop into the pot without blocking the opening of the pot. This allows users to easily spoon out the contents of the pot while the lid is positioned in the lid holding device.

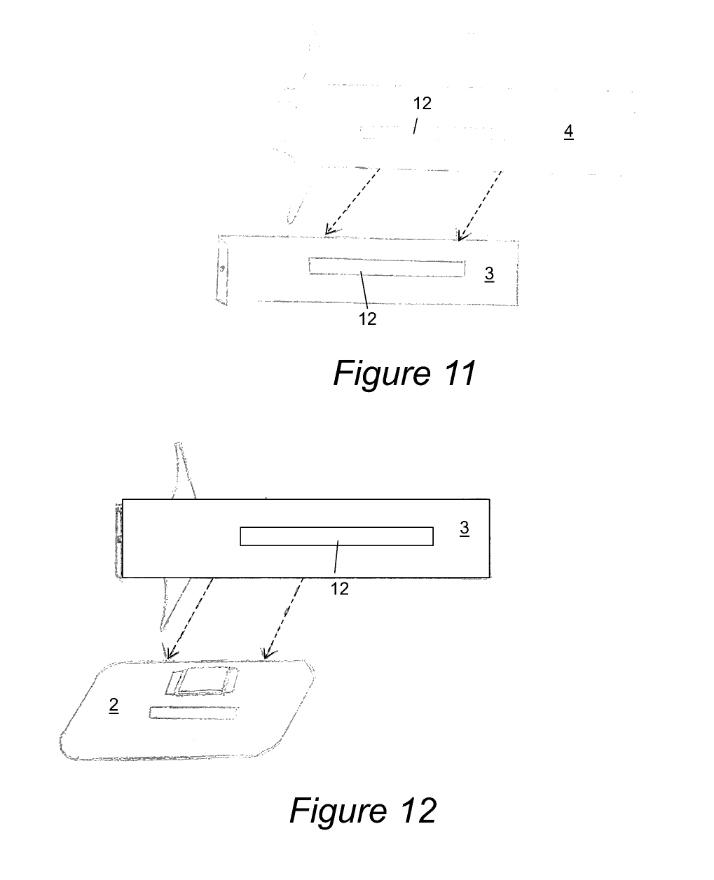

FIG. 11 shows the attachment 4 being placed on the extension 3 for storage.

FIG. 12 shows the extension 3 and the attachment 4 being positioned on base 2 for attachment and storage. This base 2 must be of a size that will fit into the intended pot for storage. As indicated above, base 2 may be a small base or a larger base that either folds or slides to reduce its overall size.

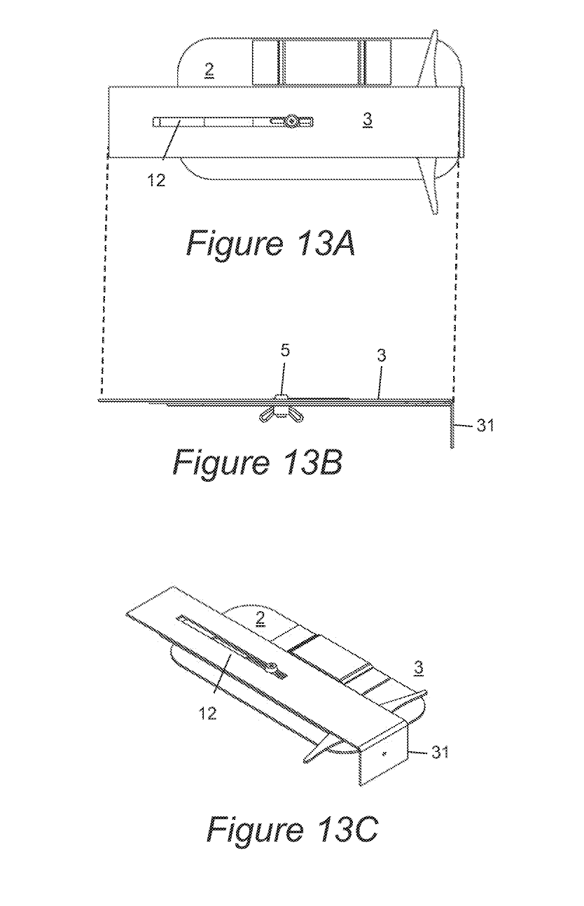

FIGS. 13A, 13B and 13C show three different views of the extension 3 and base 2 of FIG. 12 attached together sandwiching the attachment (4 of FIG. 11) for storage. FIG. 13A is s top plan view, FIG. 13B is a side elevational view and FIG. 13C is a perspective view.

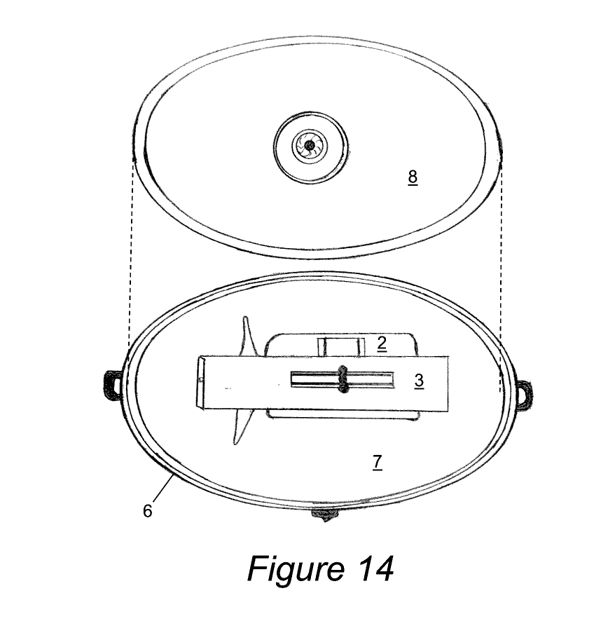

The bottom of FIG. 14 is a plan view of the pot 6 having the extension 3, attachment 4 and base 2 of FIGS. 11-13C attached together being stored within the opening 7 of pot 6.

The top of FIG. 14 shows an oval lid 8 that is intended to be used with pot 6. As shown, the lid holding device may be stored in an average sized crock pot so it will be available when the pot is being used.

Several of the embodiments of the lid holding device are designed to adjust to handle different types of handles or different sizes, and adapt to and hold lids of various heights at an angled or vertical position allowing drippings from the lid to fall into the pot while not substantially blocking the pot opening. This allows users to easily serve themselves without the lid interfering with them. It is stabilized by the substantial weight of the pot and its contents resting on the base and results in a stable, adjustable design.

While the invention has been described in conjunction with specific embodiments thereof it is evident that many alternatives, modifications and variations will be apparent to those skilled in the art. Accordingly, the preferred embodiments of the invention, as set forth herein, are intended to be illustrative, not limiting. Various changes may be made without departing from the true spirit and full scope of the invention, as defined in the following claims.

What is claimed is:

1. A lid holding device 1 for holding a lid 8 by a handle 9 above a pot 6 comprising:
(a) a flat base adapted to support the pot;
(b) an extension attached to the flat base extending at an angle upwardly from the flat base; and
(c) an attachment connected to the extension sized and shaped to receive and hold said handle 9 causing the lid 9 to be in a substantially vertical position over the pot.

2. The lid holding device 1 of claim 1 wherein the attachment 3 has a pair of upward projections 27 which point substantially upward adapted to receive and secure a loop handle 9 of a lid 8.

3. The lid holding device 1 of claim 4 further comprising:
a recess acting as a rest 13 to receive a knob handle 9 of a lid 8 and secure it.

4. The lid holding device 1 of claim 3 wherein the attachment 4 further comprises:
an adjustable stabilizing structure 53 protruding outward from the attachment 4 toward the lid 8 to hold the lid 8 away from the attachment 4 at a desired orientation.

5. The lid holding device 1 of claim 1 wherein the extension 3 angles slightly toward the pot 6 to allow the lid 8 to be held over the pot 6 allowing for any liquids in the lid 8 to drip back into the pot 6.

6. The lid holding device 1 of claim 1 wherein the pot 6 is a crock pot.

7. The lid holding device 1 of claim 3 wherein the fastener 5 includes a screw 35 and 37 nut.

8. The lid holding device 1 of claim 1, wherein said extension 3 further comprises a through mortise 12.

9. The lid holding device 1 of claim 1, wherein said attachment 4 is held to the extension 3 with a fastener 5.

10. A lid holding device 1 for holding one of a plurality of different lids 8 each designed to cover a pot 6 and each having a handle 9 comprising:
(a) a flat base 2 for receiving and supporting the pot 6 having a top opening 7;
(b) an extension 3 attached to the base 2 at an adjustable angle relative to the base 2;
(c) an attachment 4 adjustably attached to the extension 3 allowing an adjustable length of the extension 3 and attachment 4, allowing for different heights to accommodate different sized and shaped lids 8 and insure that the lids 8 are positioned in one of a tilted and vertical orientation over the pot 6;
wherein the attachment 4 comprises:
(i) structures designed to hold different types and sizes of handles 9 of the lids 8; and
(ii) a stabilizing structure 53 extending substantially horizontally from one of the attachment 4 and the extension 3, the stabilizing structure 53 holding lid 8 at a desired orientation;
(iii) wherein the angle of the extension 3 and attachment 4, the length of the extension 3 and attachment 4 can be adjusted to position different sized lids in a proper position over the pot without blocking the pot opening.

11. The pot lid holding device 10 of claim 8 wherein the base 2 is attached to the extension 3 at an adjustable angle with an angle adjustment mechanism 40, causing the base 2 to be secured to the extension 3 at a desired angle.

12. A lid holding device 1 adaptable to a variety of different lids 8 comprising:
(a) a flat base 2 for receiving and supporting a pot 6;
(b) an extension 3 extending upward at an angle toward the pot 6;
(c) an attachment 4 adjustably coupled to the extension 3 to adjust a total length of the extension 3 and attachment 4, the attachment 4 comprising:
at least two upward projections extending upward from the attachment, the projections becoming narrower as they extend upward, sized and shaped to fitting between ends of a loop handle of a lid to secure the loop handle and lid.

13. The lid holding device 1 of claim 12 further comprising:
a recess 14 having a curved rest 13 between the upward projections 27 adapted to receive a knob handle 9 of a lid 8 and secure the lid 8.

14. The lid holding device 1 of claim 12 wherein the attachment 4 further comprises:
a recess 14 that narrows as it extends downward, allowing it to secure knob handles 9 of different diameters.

15. The lid holding device 1 of claim 12 further comprising:
an angle adjustment mechanism 40 which allows the extension 3 to attach to and extend from the base 2 at a desired leaning angle to ensure that various sized lids 8 are held over the pot 6 and are allowed to drain in the pot 6.

16. The lid holding device 1 of claim 12 wherein the flat base 2, extension 3 and attachment 4 are sized to be disassembled, attached together, and stored within a standard sized crock pot.
